(19) United States
(12) Patent Application Publication
(10) Pub. No.: US 2014/0002437 A1
(43) Pub. Date: Jan. 2, 2014

(54) POWER-SAVING DRIVING CIRCUIT AND POWER-SAVING DRIVING METHOD FOR FLAT PANEL DISPLAY

(71) Applicant: NOVATEK MICROELECTRONICS CORP., Hsinchu (TW)

(72) Inventors: Keko-Chun Liang, Hsinchu City (TW); Yueh-Hsiu Liu, Hsinchu City (TW)

(73) Assignee: NOVATEK MICROELECTRONICS CORP., Hsinchu (TW)

(21) Appl. No.: 13/751,159

(22) Filed: Jan. 28, 2013

(30) Foreign Application Priority Data
Jun. 29, 2012 (TW) 101123478

(51) Int. Cl. G09G 3/36

(52) U.S. Cl. CPC G09G 3/3696
USPC 345/212

(57) ABSTRACT

A power-saving driving circuit for a flat panel display is provided. The power-saving driving circuit includes a pixel array and at least one source driver. The pixel array composes as a plurality of data lines. The data lines are grouped into a plurality of pixel regions according to a scan time. Each of the pixel regions has a plurality of pixels. The source driver sequentially supplies a driving voltage to the pixels on at least one of the data lines. The driving voltage supplied by the source driver to each of the pixel regions has a varying driving capability, and the driving capability gets stronger as it gets closer to an end of the data lines.

### CROSS-REFERENCE TO RELATED APPLICATION

This application claims the priority benefit of Taiwan application serial no. 101123478, filed on Jun. 29, 2012. The entirety of the above-mentioned patent application is hereby incorporated by reference herein and made a part of this specification.

### BACKGROUND OF THE INVENTION

1. Field of the Invention

The invention relates to a power-saving driving circuit and a power-saving driving method for a flat panel display.

2. Description of Related Art

In a conventional flat panel display (for example, a liquid crystal display (LCD), when data is input to the data lines, in order to allow those pixels farther away from the source driver to achieve a proper voltage level for displaying data, the driving voltage output by the source driver should have an adequate driving capability. If the driving capability is inadequate, because the driving voltage attenuates on the date lines before it reaches the pixels farther away from the source driver, the gray level actually displayed by each pixel is different from the input data.

In addition, because the pixels on a same data line would have different voltage levels to meet the demand of displayed image, the load on the data line is repeatedly charged/discharged. Such charging/discharging operations also increase the power consumption of the source driver.

Thereby, how to reduce the power consumption of the source driver should be considered in product design.

### SUMMARY OF THE INVENTION

In embodiments of the invention, the power consumed by loads on data lines is reduced without sacrificing the display quality of a liquid crystal display (LCD).

An embodiment of the invention provides a power-saving driving circuit for a LCD. The power-saving driving circuit includes a pixel array and at least one source driver. The pixel array includes a plurality of data lines. The data lines are grouped into a plurality of pixel regions according to a scan time. Each of the pixel regions has a plurality of pixels. The source driver sequentially supplies a driving voltage to the pixels on at least one of the data lines. The driving voltage supplied by the source driver to each of the pixel regions has a varying driving capability, and the driving capability gets stronger as it gets closer to an end of the data lines.

An embodiment of the invention provides a power-saving driving method for a LCD. The power-saving driving method is adapted to drive a pixel array. The pixel array includes a plurality of data lines. In the power-saving driving method, the data lines are grouped into a plurality of pixel regions according to a scan time, and each of the pixel regions has a plurality of pixels. A driving voltage is sequentially supplied to the pixels on each of the data lines by using a plurality of source drivers. The driving voltage supplied by the source driver to each of the pixel regions has a varying driving capability, and the driving capability gets stronger as it gets closer to an end of the data lines.

An embodiment of the invention provides a power-saving driving method for a LCD. The power-saving driving method is adapted to drive a pixel array. The pixel array includes a plurality of data lines driven by at least one source driver. The power-saving driving method includes following steps. When the source driver charges/discharges a far pixel region of the data lines farther away from the source driver, the output of the source driver maintains a first charge driving capability so that the data lines can have a proper level of charges at the far pixel region. When the source driver charges/discharges a near pixel region of the data lines closer to the source driver, the output of the source driver maintains a second charge driving capability so that the data lines can have a proper level of charges at the near pixel region. The second charge driving capability is weaker than the first charge driving capability.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating the load on a data line of a liquid crystal display (LCD) according to an embodiment of the invention.

FIG. 2 is a diagram illustrating a LCD scanning mechanism according to an embodiment of the invention.

FIG. 3 is a diagram illustrating a LCD scanning mechanism according to an embodiment of the invention.

FIG. 4 is a diagram illustrating how a farther load on a data line is charged according to an embodiment of the invention.

FIG. 5 is a diagram illustrating how a nearer load on a data line is charged according to an embodiment of the invention.

FIG. 6 is a diagram of a pixel array according to an embodiment of the invention.

FIG. 7 is a diagram illustrating how to calculate the position of a currently scanned pixel according to a control signal YDIO according to an embodiment of the invention.

FIG. 8 is a diagram illustrating the charging states of three driving capabilities corresponding to three nodes A, B, and C according to an embodiment of the invention.

FIG. 9 is a diagram illustrating a mechanism of classifying a driving capability based on the rising or falling speed of the rising edge of a driving voltage signal according to an embodiment of the invention.

FIG. 10 is a diagram illustrating a mechanism of classifying a driving capability based on charge areas according to an embodiment of the invention.

FIG. 11 is a diagram illustrating a mechanism of classifying a driving capability based on charge areas according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In the invention, the loads of data lines corresponding to different scan positions are analyzed in detail, and a power-saving driving mechanism is provided based on the analysis result to reduce the power consumption and achieve an energy saving effect.

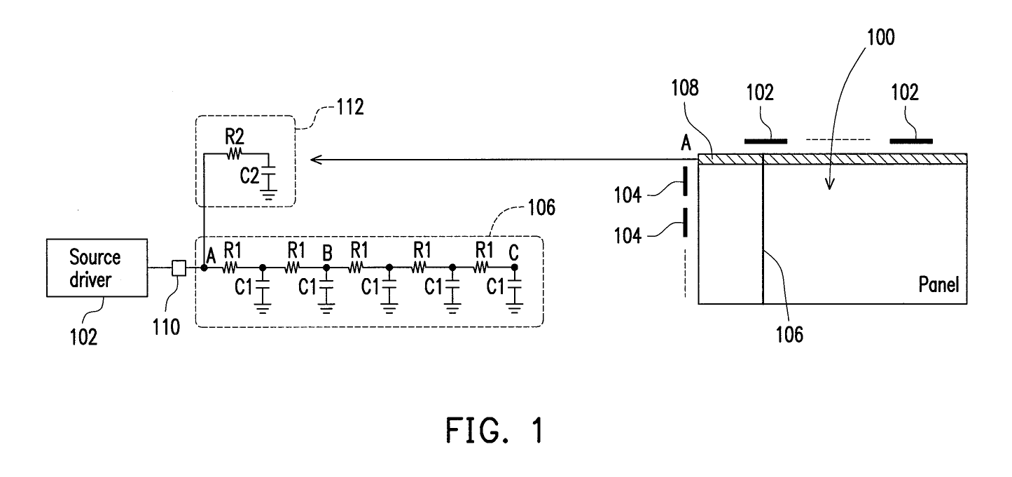

FIG. 1 is a diagram illustrating the load on a data line of a liquid crystal display (LCD) according to an embodiment of the invention. Referring to FIG. 1, a pixel array 100 is disposed on the display panel. The pixel array 100 is controlled by a plurality of source drivers 102 and a plurality of gate drivers 104. The pixel array 100 is usually a 2-dimensional (M×N) pixel array, and in which the pixels along the vertical direction constitute a plurality of data lines 106, and the pixels along the horizontal direction constitute a plurality of scan lines 108. The scan lines 108 are controlled by the gate drivers 104 to sequentially start the pixels. Meanwhile, the source drivers 102 supply driving voltages corresponding to desired gray levels to the pixels via the data lines 106 to display image data. An image is displayed on the display panel after the scanning of one frame is completed.

Regarding one data line 106 in the equivalent circuit, the load equivalent circuit 112 of a pixel on the data line 106 includes an equivalent resistor R2 of a transistor switch and a storage capacitor C2 for storing pixel data voltage. Based on the resolution design of M×N, the data line 106 has N pixels. Taking a five-stage equivalent load circuit as an example, resistance for each single stage load on the data line 106 is indicated as R1, and the parasitic capacitance for each single stage load on the data line 106 is indicated as C1.

Referring to FIG. 1, the scan line 108 charges/discharges the pixel A near the source driver 102. The source driver 102 outputs a driving voltage (i.e., a data voltage) to the data line 106 through a bump 110. A pixel at node A started by the scan line 108 is denoted with diagonal lines on the display panel, and which turns on the transistor switch of the corresponding pixel. Meanwhile, the driving voltage supplied to the pixel by the source driver 102 is corresponding to the data of the pixel. The voltage corresponding to the data of the pixel needs to charge/discharge the storage capacitor C2.

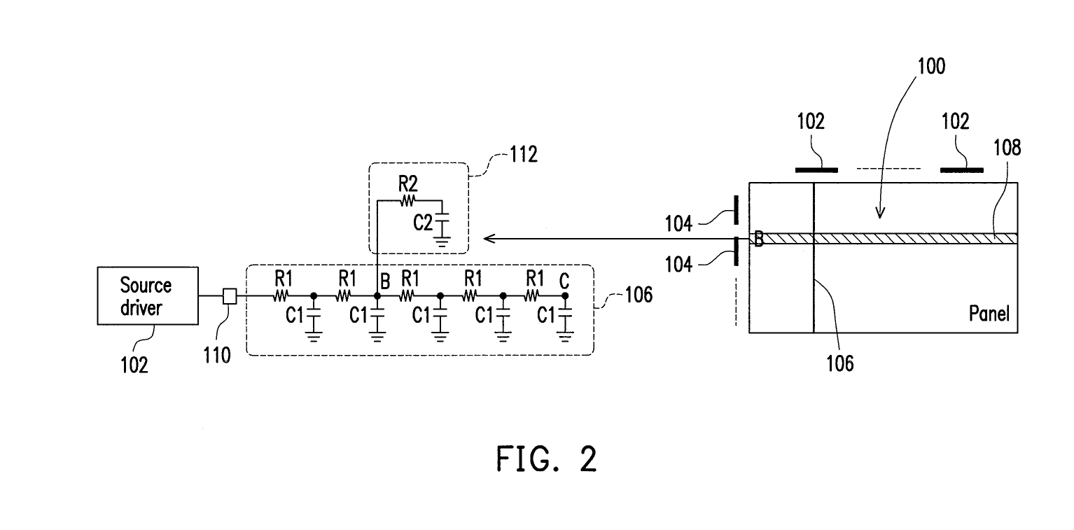

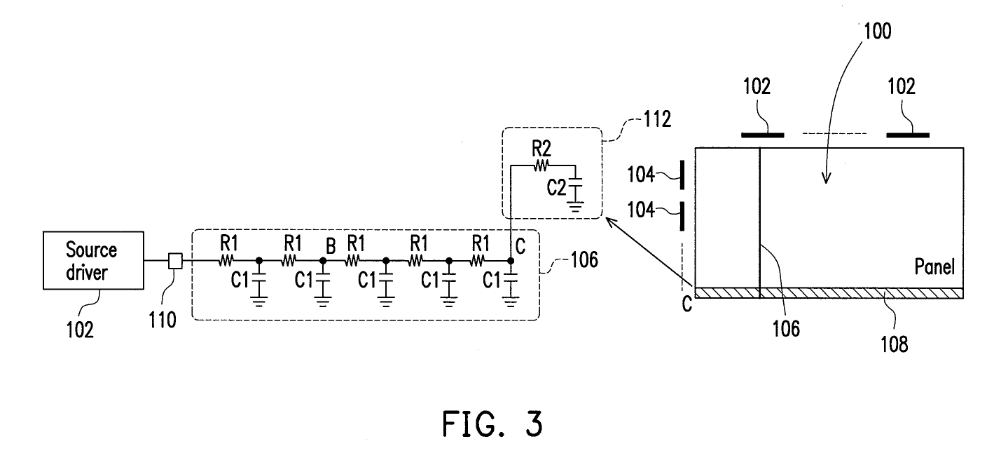

Regarding pixels at different positions on each scan line 108, the storage capacitors C2 are charged/discharged in the same way. In FIG. 2, a pixel at node B on the data line 106 started by the scan line 108 is denoted with diagonal lines on the display panel. The node B represents a pixel farther away from the source driver 102. In FIG. 3, a pixel at node C on the data line 106 started by the scan line 108 is denoted with diagonal lines on the display panel. The node C represents a pixel farthest away from the source driver 102.

On the display panel of the LCD, the parasitic capacitance C1 of each stage on the data line 106 is usually greater than the storage capacitance C2 of a single pixel. Thus, in order to ensure that the pixels at the nodes A, B, and C to have voltages at proper levels, the outputs of the source drivers 102 have to have adequate charge driving capabilities and should be able to fully charge the resistors R1 and capacitors C1 of the all five stages on the data lines 106 without considering the power consumption. The voltages supplied to the pixels at nodes A, B, and C may be very different due to different pixel data or polarities. As a result, the loads on the data lines 106 may be repeatedly charged/discharged, which will drastically increase the power consumption of the source drivers 102.

In an embodiment of the invention, when a source driver charges/discharges a far pixel, the output of the source driver maintains a regular charge driving capability so that the pixel can be properly charged under the impact of the load on the data line. When the source driver charges/discharges a near pixel, the output of the source driver maintains a lower charge driving capability, or a smaller charge/discharge area is assumed, so that only the load on the near data line is charged with the desired amount of charges and the storage capacitor of the near pixel achieves voltage at a proper level while the loads on those far data lines are not fully charged. Regarding the five-stage RC equivalent load circuits on a data line, when a lower charge driving capability is adopted (for example, the parasitic capacitor C1 of the first stage equivalent load circuit is charged to a desired voltage level), the equivalent load circuits of the other stages may not be fully charged. However, since the pixels of the first stage equivalent load circuit achieve the desired voltage level, the display effect of the pixels of the first stage equivalent load circuit is not affected even though the pixels of the rest equivalent load circuits are not fully charged. Compared to the situation that equivalent load circuits in all five stages are fully charged, less power is consumed since the far parasitic capacitors on the data lines consume less power. Thereby, when near pixels are driven, the power consumed by far loads is reduced, and the power consumed on the data lines for data conversion or polarity transformation is also reduced, so that the power consumption of the LCD is reduced. Namely, the source drivers maintain weaker charge driving capabilities when near pixels are driven so that the power consumption is reduced.

Below, the charging state of the data lines when pixels at different positions are charged/discharged will be described.

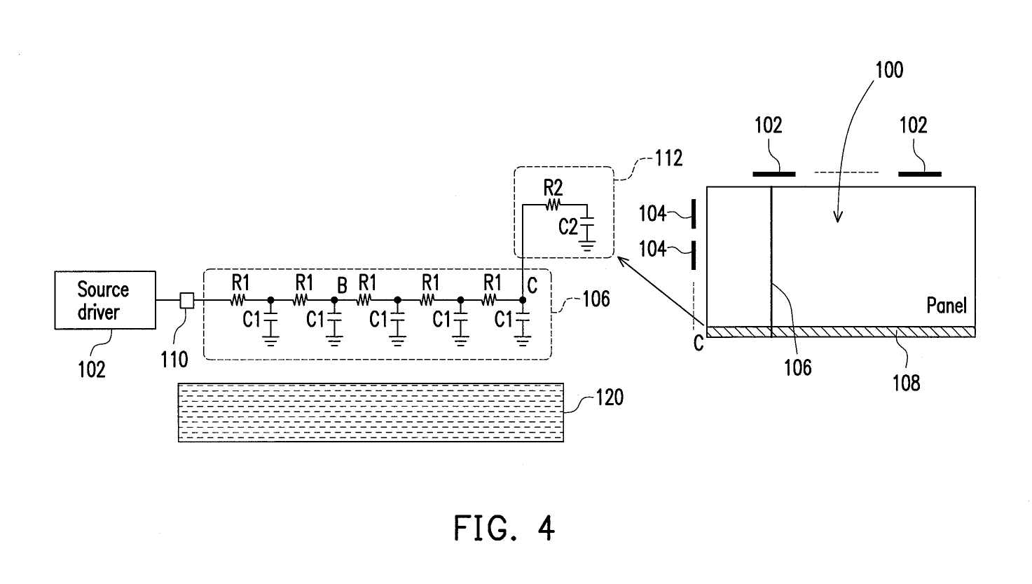

FIG. 4 is a diagram illustrating how a farther load on a data line is charged according to an embodiment of the invention. Referring to FIG. 4, when data is written to pixels at node C on the data lines, all the parasitic capacitors C1 of the data lines need to be fully charged in order to allow the pixels at the node C to have a proper voltage level. The charge state is as shown by the state pattern 120. All the pixels on a data line 106 need to be fully charged to avoid affecting the voltage on the storage capacitors C2 of the pixels. Namely, the source drivers need to maintain a strong driving capability to achieve the situation mentioned above.

Assuming that the last pixels are at the node C, the driving capability need to be the strongest (i.e., the regular driving capability applicable to all the pixels in a general design). However, power is wasted if data is written to the pixels at the node A with such regular driving capability.

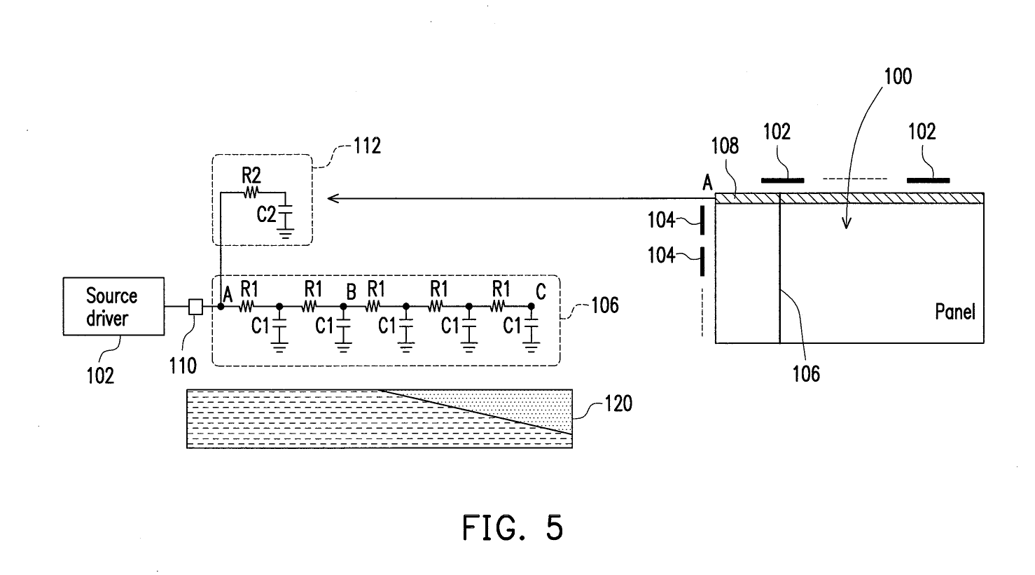

FIG. 5 is a diagram illustrating how a nearer load on a data line is charged according to an embodiment of the invention. Referring to FIG. 5, when data is written to a pixel at the node A on a data line (for example, the first pixel), only the parasitic capacitor C1 and the storage capacitor C2 at the node A on the data line need to be fully charged. The display of the pixel at the node A is not affected regardless of whether those pixels after node A (for example, the capacitors at the node B and the node C) are fully charged.

The charge state is as shown by the state pattern 120. When near pixels are charged/discharged, a weaker driving capability can be maintained to fully charged the parasitic capacitors C1 and the storage capacitors C2 of the load circuits at the node A on the data lines as long as the pixels at the node A on the data lines are fully charged. However, the parasitic capacitors C1 after the node A (for example, at the node B or the node C) can be partially charged (the incomplete state shown by the state pattern 120) to reduce the power consumption caused by data difference or polarity difference. Herein even though the parasitic capacitors C1 at the node B or the node C are not fully charged, the display of the pixels at the node A is not affected even though the parasitic capacitors C2 of the pixels at the node B or the node C are not fully charged.

The charge driving capability can be changed in many ways, such as the technique described in detail later on with reference to FIGS. 9-11. Below, the data lines are grouped into three pixel regions corresponding to aforementioned nodes A, B, and C. However, the number of the pixel regions is not limited thereto, and there may be two or more than three pixel regions. The number of pixels in each pixel region is determined according to the number of the pixel regions. Namely, pixels on the data lines are grouped into a plurality of pixel regions. Below, for the convenience of description, each pixel region is denoted as a node. In the present embodiment, pixels in three pixel regions are denoted as nodes A, B, and C.

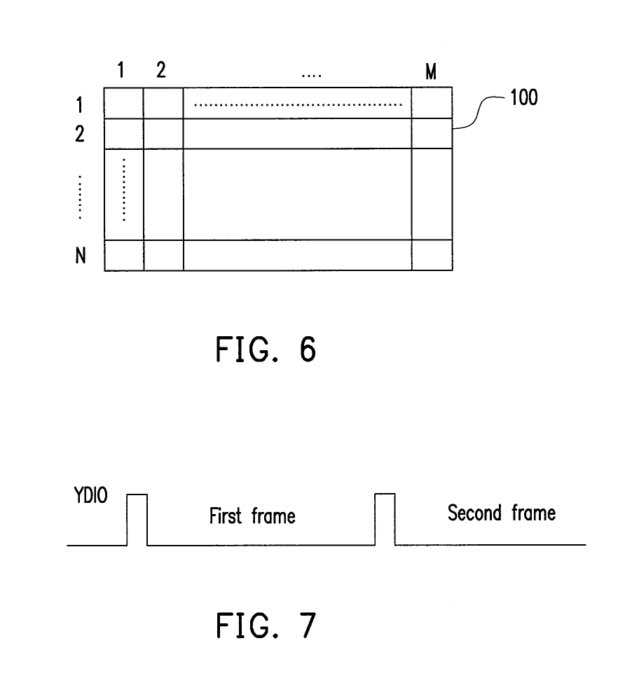

FIG. 6 is a diagram of a pixel array according to an embodiment of the invention. Referring to FIG. 6, regarding an M×N pixel array 100, corresponding pixels can be denoted with 2D array elements. M and N are positive integers, and which are generally referred to as a resolution. A color pixel may be composed of three sub pixels of primitive colors, which is well known by those skilled in the art therefore will not be explained herein. In an embodiment of the invention, there are N pixels on each data line, and the pixels are grouped into three equal pixel regions (i.e., each pixel region has about N/3 pixels). If there are L pixel regions (L is greater than or equal to 2), each pixel regions has about N/L pixels. In the embodiment described above, L=3. However, the pixel regions may not be equal to each other. Namely, the numbers of pixels in the pixel regions may not be approximately the same.

The pixel region corresponding to a pixel to be written can be identified according to a control signal YDIO of a frame or according to the scan timings of the gate drivers. Or, the position of the pixel on a data line, and accordingly the pixel region corresponding to the pixel, can be determined according to the number of pixels on the entire frame.

FIG. 7 is a diagram illustrating how to calculate the position of a currently scanned pixel according to the control signal YDIO according to an embodiment of the invention. Referring to FIG. 7, data of a frame is input after one pulse of the control signal YDIO, in which M×N pixels are input as a string. Thus, the position and the corresponding data line, and accordingly the corresponding pixel region, of a pixel can be determined according to the number of the pixel. The source driver driving the data line outputs a signal of different driving capability according to the distance of the pixel region.

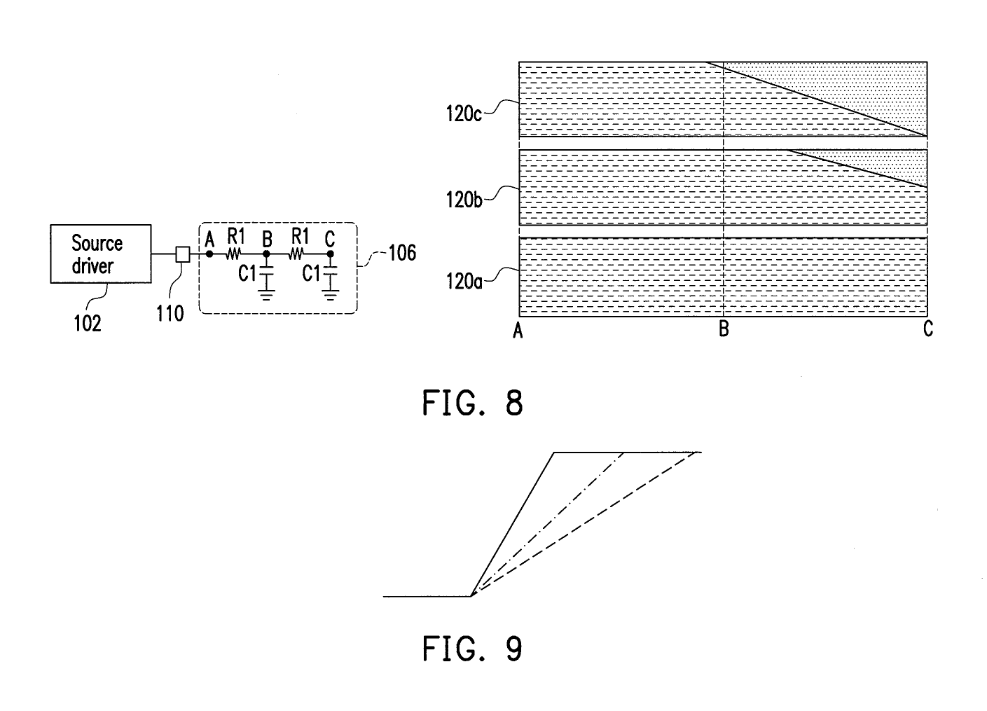

FIG. 8 is a diagram illustrating the charging states of three driving capabilities corresponding to three nodes A, B, and C according to an embodiment of the invention. Referring to FIG. 8, the state pattern 120a shows a charge state with the highest driving capability, in which the pixels at the node C are driven. Because the pixels at the node C are the farthest pixels, when the parasitic capacitors C1 and the storage capacitors C2 of the pixels at the node C are fully charged, the parasitic capacitors C1 and the storage capacitors C2 of the pixels at the nodes A and B are also fully charged.

The state pattern 120b shows a charge state with a medium driving capability. The strength of the driving capability is just adequate for properly driving the pixels at the node B. Thus, the parasitic capacitors C1 and the storage capacitors C2 of the pixels at the node C need not to be charged to the voltage on the pixels at the node B at the same time when the pixels at the node B display data properly. Herein the parasitic capacitors C1 and the storage capacitors C2 of the pixels at the node A are already fully charged. However, the power will be wasted if a high driving capability is adopted to maintain the charge state of the pixels at the node C as that shown by the state pattern 120a.

The state pattern 120c shows a charge state with a low driving capability. The strength of the driving capability is just adequate for properly driving the pixels at the node A. Thus, the pixels at the nodes B and C need not to be fully charged along with the pixels at the node A when the pixels at the node A display data properly. Thereby, pixels in the nearest pixel regions on the data lines display data properly, while the rest pixels, regardless of whether the parasitic capacitors C1 and the storage capacitors C2 thereof are fully charged or not, won't affect the display of the pixels at the node A. The power will be wasted if a high driving capability is adopted to maintain the charge state of the pixels at the node B and the node C as that shown by the state pattern 120a.

Based on the driving mechanism described above or illustrated in FIG. 8, the driving capability of a source driver should be adjusted to achieve a power-saving effect.

Below, how the driving capability is adjusted will be explained with reference to embodiments of the invention. However, these embodiments are not intended to limit the scope of the invention.

FIG. 9 is a diagram illustrating a mechanism of classifying a driving capability based on the increasing or decreasing speed of the rising edge of a driving voltage signal according to an embodiment of the invention. FIG. 9 illustrates the waveform of the driving voltage signal output by a source driver. Regarding the charging characteristic of a RC circuit, the rising speed or falling speed of its voltage is determined by different circuit design conditions, and the power consumed by the RC circuit varies with the rising or falling speed of the voltage. To be specific, the higher the rising speed is, the more power is consumed. The rising edge of the dashed line has a relatively slow rising speed therefore can be used for driving the pixels at the node A. The rising edge of the dotted line has an intermediate rising speed therefore can be used for driving the pixels at the node B. The rising edge of the solid line has the fastest rising speed therefore can be used for driving the pixels at the node C.

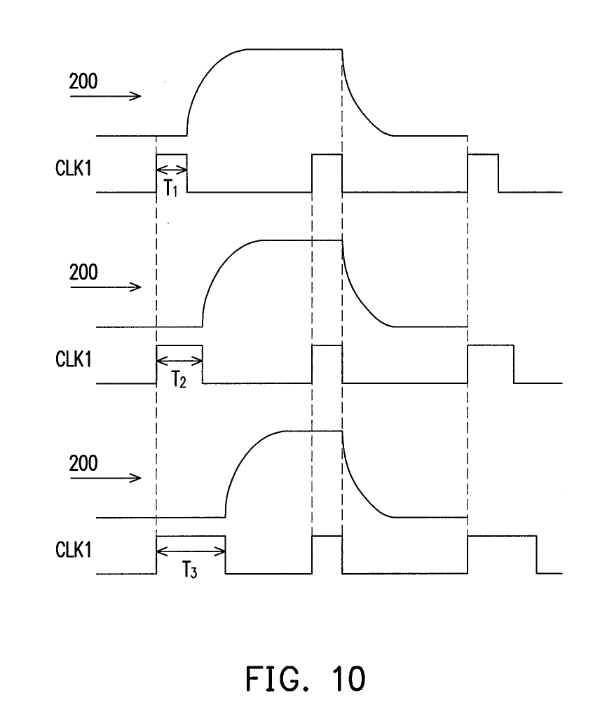

FIG. 10 is a diagram illustrating a mechanism of classifying a driving capability based on charge areas according to an embodiment of the invention. Referring to FIG. 10, regarding the waveform of the driving voltage signal output by a source driver, if the rising speed thereof is not changed, the signal width can be changed. As a result, the charge area (product of time width and voltage), and accordingly the driving capability, is changed.

Generally, the driving voltage signal 200 output by a source driver is generated according to a clock signal CLK1. For example, the high and low levels of the driving voltage signal 200 are sequentially changed according to the falling edges of the clock signal CLK1. By changing the pulse widths T1, T2, and T3 of the clock signal CLK1, the happening time of the high level of the driving voltage signal 200 is changed, and accordingly the signal width is changed. In an embodiment with three pixel regions, the pulse widths T1, T2, and T3 has such a relationship as T1<T2<T3. The pulse width T1 may be the pulse width of the original clock signal CLK1, and the charge area thereof is the largest. Thus, the pulse width T1 is used for driving the pixels in the farthest pixel regions.

The pulse width T2 is greater than the pulse width T1 according to the actual design. Thus, the charge area thereof is reduced and the pulse width T2 is used for driving the pixels at the node B. Herein the storage capacitors and the parasitic capacitors of the pixels at the node C need not to be fully charged when the pixels at the node B display data properly. Due to the decrease in the charge area, the power consumption is reduced.

The pulse width T3 is greater than the pulse width T2 according to the actual design. Thus, the charge area is further reduced and the pulse width T3 is used for driving the pixels at the node A. Herein the parasitic capacitors and storage capacitors of the pixels in the pixel regions corresponding to the nodes B and C need not to be fully charged when the pixels at the node A display data properly. Due to the decrease in the charge area, the power consumption is reduced.

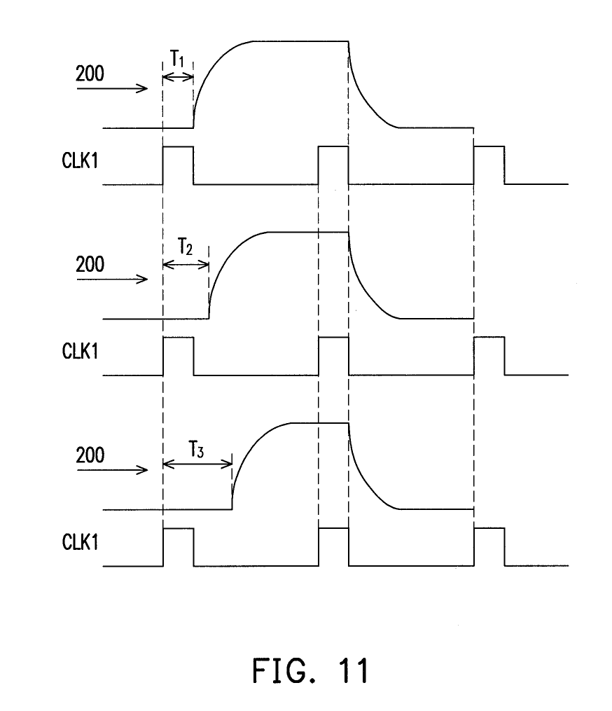

FIG. 11 is a diagram illustrating a mechanism of classifying a driving capability based on charge areas according to an embodiment of the invention. Referring to FIG. 11, when the mechanism of changing the charge area is adopted and the rising speed of the driving voltage signal 200 is not changed (as shown in FIG. 10), the change of the signal width can be accomplished through time delay. In the present embodiment, the pulse width of the clock signal CLK1 remains its original width, but the triggering of the driving voltage signal 200 output by the source driver is delayed. The delay time is set according to the relationship of the pulse widths T1, T2, and T3 (T1<T2<T3). However, this mechanism is accomplished through delay triggering, and the effect is as shown in FIG. 11.

The change of the charge area is not only accomplished through the techniques illustrated in FIG. 10 and FIG. 11. Instead, it may also be accomplished according to a different signal or through a different mechanism.

According to an embodiment of the invention, near and far loads on a display panel are driven with different driving capabilities or different charge areas, so that when pixels at a near end are driven, the parasitic capacitors and storage capacitors at a far end need not to be fully charged. Thereby, fewer charges are converted and a power-saving effect is achieved.

Based on the same mechanism, the application of the invention is not limited to LCD. Instead, the invention may also be applied to other light emitting diode (LED) displays. The invention can be applied to a regular flat panel display. The flat panel display has a pixel array, and the pixels are driven with scan lines and data lines.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A power-saving driving circuit for a flat panel display, the power-saving driving circuit comprising:
a pixel array, composing as a plurality of data lines, wherein the data lines are grouped into a plurality of pixel regions according to a scan time, and each of the pixel regions has a plurality of pixels; and
at least one source driver, sequentially supplying a driving voltage to the pixels on at least one of the data lines,
wherein the driving voltage supplied by the source driver to each of the pixel regions has a varying driving capability, and the driving capability is getting stronger as getting closer to an end of the data lines.

2. The power-saving driving circuit according to claim 1, wherein the varying driving capability is classified according to a rising speed of a signal rising edge of the driving voltage, and the faster the rising speed is, the stronger the driving capability is.

3. The power-saving driving circuit according to claim 1, wherein the varying driving capability is classified according to a start-up time width of the driving voltage, and the greater the start-up time width is, the stronger the driving capability is.

4. The power-saving driving circuit according to claim 3, wherein the start-up time width is controlled by a clock signal received by the source driver, and the clock signal triggers a start time and an end time of the driving voltage to change the start-up time width.

5. The power-saving driving circuit according to claim 4, wherein the clock signal has a first pulse width and a second pulse width that are alternatively produced, the first pulse width varies with the driving capability, and the smaller the first pulse width is, the stronger the driving capability is.

6. The power-saving driving circuit according to claim 4, wherein the clock signal is a plurality of pulses, and every two of the pulses complete the driving voltage that is triggered once, wherein the start time has a delay time relative to the pulses that varies with the driving capability, and the shorter the delay time is, the stronger the driving capability is.

7. The power-saving driving circuit according to claim 1, wherein a number of the pixel regions is at least 3.

8. A power-saving driving method for a flat panel display, adapted to drive a pixel array, wherein the pixel array composes as a plurality of data lines, the power-saving driving method comprising:
grouping the data lines into a plurality of pixel regions according to a scan time, wherein each of the pixel regions has a plurality of pixels; and
sequentially supplying a driving voltage to the pixels on each of the data lines by using a plurality of source drivers,
wherein the driving voltage supplied by the source drivers to each of the pixel regions has a varying driving capability, and the driving capability is getting stronger as getting closer to an end of the data lines.

9. The power-saving driving method according to claim 8, wherein the varying driving capability is supplied according to a rising speed of a signal rising edge of the driving voltage, and the faster the rising speed is, the stronger the driving capability is.

10. The power-saving driving method according to claim 8, wherein the varying driving capability is supplied according to a start-up time width of the driving voltage, and the greater the start-up time width is, the stronger the driving capability is.

11. The power-saving driving method according to claim 10, wherein the start-up time width is controlled by a clock signal received by the source drivers, and the clock signal triggers a start time and an end time of the driving voltage to change the start-up time width.

12. The power-saving driving method according to claim 11, wherein the clock signal has a first pulse width and a second pulse width that are alternatively produced, the first pulse width varies with the driving capability, and the smaller the first pulse width is, the stronger the driving capability is.

13. The power-saving driving method according to claim 12, wherein the clock signal is a plurality of pulses, and every two of the pulses complete the driving voltage that is triggered once, wherein the start time has a delay time relative to the pulses that varies with the driving capability, and the shorter the delay time is, the stronger the driving capability is.

14. The power-saving driving method according to claim 8, wherein a number of the pixel regions is at least 3.

15. A power-saving driving method for a flat panel display, adapted to drive a pixel array, wherein the pixel array composes as a plurality of data lines, and the data lines are driven by at least one source driver, the power-saving driving method comprising:
when the source driver charges/discharges a far pixel region of the data lines far away from the source driver, maintaining a first charge driving capability of an output of the source driver to allow the data lines to have a proper level of charges at the far pixel region; and
when the source driver charges/discharges a near pixel region of the data lines near the source driver, maintaining a second charge driving capability of the output of the source driver to allow the data lines to have a proper level of charges at the near pixel region,
wherein the second charge driving capability is weaker than the first charge driving capability.
